(19) United States
(12) Patent Application Publication
(10) Pub. No.: US 2010/0045206 A1
(43) Pub. Date: Feb. 25, 2010

(54) LED Driving Circuit

(76) Inventor: Sheng-Yi CHUANG, Hsinchu City (TW)

Correspondence Address: FRENKEL & ASSOCIATES, 3975 UNIVERSITY DR., STE. 330, FAIRFAX, VA, 22030, US

(21) Appl. No.: 12/194,622

(22) Filed: Aug. 20, 2008

(51) Int. Cl. H05B 41/36

(52) U.S. Cl. 315/294

(57) ABSTRACT

An LED driving circuit to provide DC power to an LED to generate light includes a voltage-lowering regulation circuit, a rectification circuit and a filter and current-limiting circuit. The voltage-lowering regulation circuit aims to regulate impedance and provide a back electromotive force with polarity opposite to input voltage so that input power passed through the voltage-lowering regulation circuit is offset by the back electromotive force to a lower voltage. Then the input power passes through the rectification circuit to become DC power. The filter and current-limiting circuit receives the DC power and has at least one filter element to absorb or release the voltage to perform filtering and at least one current-limiting resistor to limit DC value. Therefore, the DC power has a steady voltage and current to energize the LED for lighting.

### FIELD OF THE INVENTION

The present invention relates to an LED (light-emitting diode) driving circuit and particularly to a lamp set using an LED for indoor lighting.

### BACKGROUND OF THE INVENTION

Indoor environments require different lamp sets in different occasions. For instance, office environments usually need fluorescent lamps of a greater luminance and higher color temperature to provide a brighter working environment for people. For home use, the lamp set generally aims to produce a lower luminance and color temperature to provide comfort feeling. At present, there are a wide variety of lamps available to meet all sorts of requirements. However, the conventional lamp still has lower power efficiency than LED. Given a same amount of power consumption, the LED lamp not only provides a greater luminance, but also has a longer life span. Hence LED lamps are being widely promoted nowadays to replace the conventional lamps, such as flashlights, traffic lights, vehicle lights and the like. But a great portion of households still widely use the conventional lamps and fluorescent lamps. There are many reasons for the lower popularity of LED lamp in household use, such as changing people's habits takes time, the LED lamp has a greater color temperature and luminance, hence is more irritating to human's visual sense and less likely to give people a relax sense at home. Test results indicate that such a phenomenon mainly can be attributed to the LED lamp being driven in a constant current mode. The conventional technique generally regulates the brightness of LED through a pulse width modulation (PWM) circuit and a converter that function like a switch power supply regulation. However, the general lighting bulbs used in home environments or the conventional lamp sets do not have the aforesaid circuit to control the brightness of the LED lamp. Moreover, the circuit is expensive. To adopt the LED lamp to lighting features of a lower brightness lamp set, the conventional technique generally uses multiple lamp shades to encase the LED. For instance, R.O.C. patent Nos. M329737 entitled “LED amp” and M279025 entitled “LED night light” teach a technique of filling resin between an LED and a lamp shade to scatter or attenuate the luminance. But such a technique creates other problems, such as a higher production cost and longer production time. There are still rooms for improvement.

### SUMMARY OF THE INVENTION

In view of the disadvantages of the conventional techniques that adopt LEDs to general lighting, the present invention aims to provide a small size and low cost circuit to drive an LED lamp. The circuit and LED lamp of the invention can be adopted in various types of lighting features.

The LED driving circuit according to the invention is used in lighting features that employ LEDs to generate light. The driving circuit provides DC power to an LED to generate light. The driving circuit includes a voltage-lowering regulation circuit (VLRC in short hereinafter), a rectification circuit and a filter and current-limiting circuit (FCLC in short hereinafter). The VLRC aims to regulate impedance and provide a back electromotive force with polarity opposite to input voltage so that input power passes through the VLRC and is offset by the back EMF to a lower voltage, then passes through the rectification circuit to become DC power. The FCLC receives the DC power and has at least one filter element to absorb or release the voltage to perform filtering and further has at least one current-limiting resistor to limit the DC value. The resulting DC power has a steady voltage and current to light the LED. The circuit thus formed can lower the voltage with fewer electronic elements, and can be adopted for different input voltages. When in use to drive an LED lamp, the LED generates light of a lower luminance. Moreover, the circuit is smaller in size and costs less, and is adaptable to a wide variety of environments and lighting features, thus can greatly expand the application of LED lighting.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of the invention.

FIG. 2 is a circuit diagram of the invention.

FIG. 3 is a side view of the circuit and LED according to the invention.

FIG. 4 is a schematic view of an embodiment of the invention.

FIG. 5 is another circuit diagram of the invention.

### DETAILED DESCRIPTION OF THE PREFERRED EMBODIMENTS

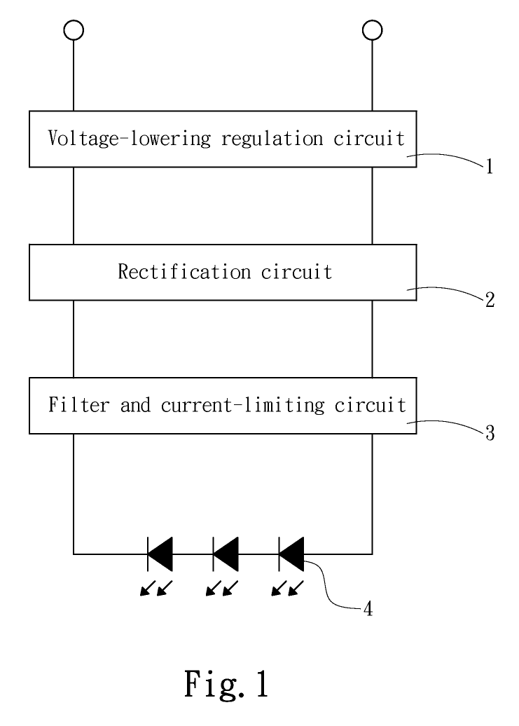

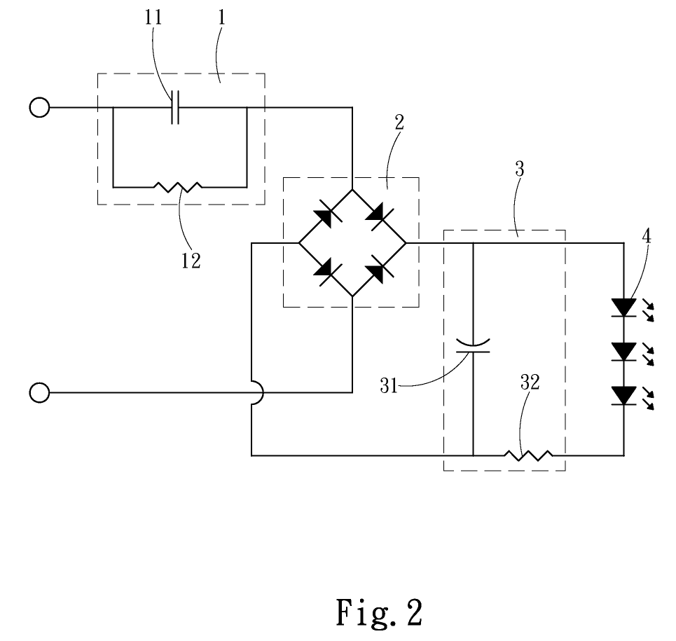

Please refer to FIG. 1, the LED driving circuit of the invention aims to deploy an LED in a lighting feature. The driving circuit regulates input power to DC power sent to an LED 4 to generate light. The driving circuit includes a voltage-lowering regulation circuit (VLRC) 1, a rectification circuit 2 and a filer and current-limiting circuit (FCLC) 3. The VLRC 1 aims to regulate impedance and provide a back EMF with polarity opposite to input voltage so that input power passed through the VLRC 1 has a lower voltage, then the input power passes through the rectification circuit 2 to become DC power. The FCLC 3 receives the DC power and has at least one filter element to absorb or release the voltage to perform filtering and at least one current-limiting resistor 32 (referring to FIG. 2) to limit the DC value. The DC power thus formed has a steady voltage and current to light the LED 4. By means of the circuit set forth above, the VLRC 1 can lower the voltage of input power, thus result the DC power of a lower voltage to drive the LED 4 to generate light. The FCLC 3 can stabilize the current and voltage. Therefore, the LED 4 can generate the light at a lower luminance to be used in different lighting applications.

Refer to FIG. 2 for an embodiment of the circuit previously discussed. The VLRC 1 includes at least one voltage lowering capacitor 11 and a discharge resistor 12 coupling in parallel. The voltage lowering capacitor 11 generates the back EMF opposite to the input power polarity. The back EMF can be got according to an equation as follow:

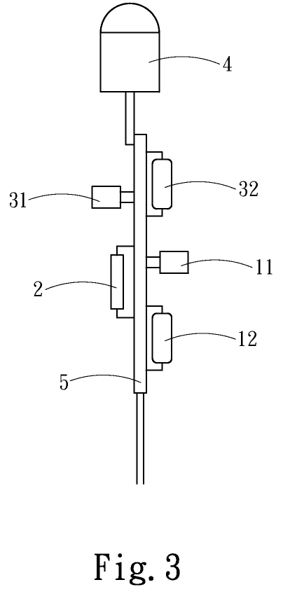

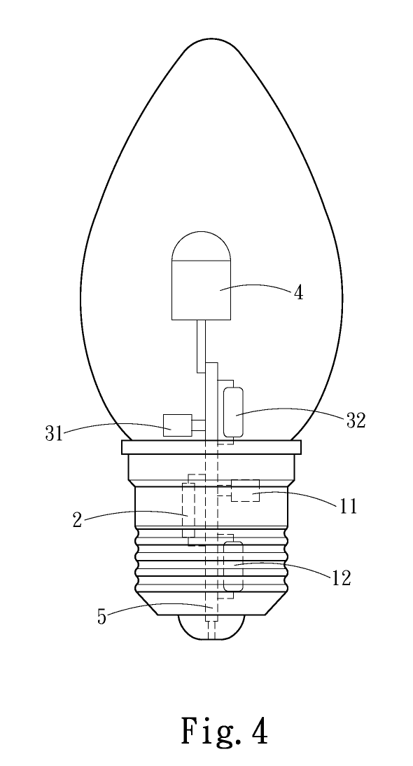

v(t)=1/C∫idt

where the amount of current i is affected by the discharge resistor 12, hence the voltage lowering capacitor 11 and discharge resistor 12 determine the size of the back EMF. The size of the back EMF can be designed according to utilization of a lighting feature, consequently alter the brightness of the LED 4. The rectification circuit 2 may be a full bridge rectification circuit. The filter element of the FLCL 3 may be a filter capacitor 31 coupling with two ends of the LED 4 in a parallel manner. The current-limiting resistor 32 and the LED 4 are coupled in series. The DC power generated from the rectification circuit 2 passes through the filter capacitor 31 and current-limiting resistor 32, and has a steady current and voltage to drive the LED 4. Refer to FIG. 3 for a structure based on the circuit previously discussed. The rectification circuit 2 is an IC chip available on the market. The driving circuit and a circuit copper foil are laid on a circuit board 5. The LED 4 is coupled on the circuit board 5. Such a structure is adoptable to a general lamp (referring to FIG. 4), or may be formed in a module consisting of a plurality of LEDs.

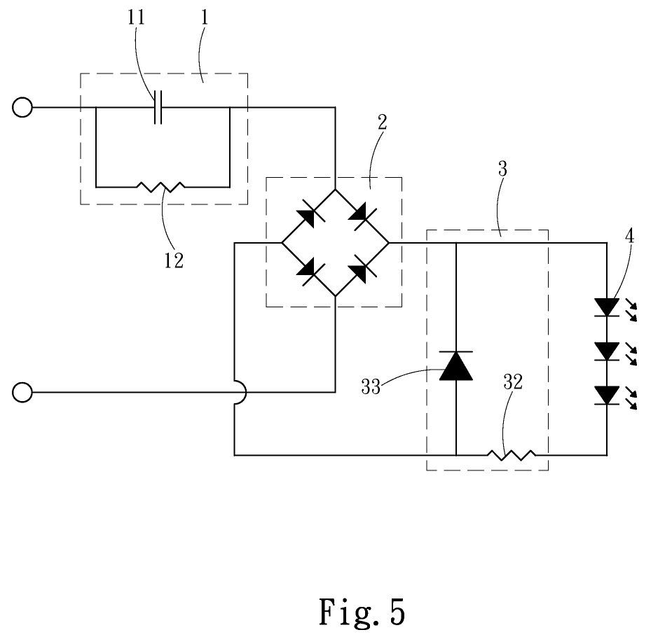

The driving circuit set forth above can be made at a compact size and lower cost to regulate the luminance of an LED. Compared with the conventional technique that does regulation through PWM, the invention is cheaper and smaller, and can substitute the conventional lamp in various types of applications. As the driving circuit previously discussed regulates input voltage through the VLRC 1, it is adaptable to varying applications of different input voltages. The applicable voltage can be ranged from 110 to 240V for high end, and 5V to 55V for low end. Thus it can be coupled with different power sources or modules. Moreover, the filter element in the FCLC 3 may also be a diode 33 (referring to FIG. 5) coupling with two ends of the LED 4 in parallel. The diode 33 can stabilize voltage and eliminate power fluctuation to achieve filtering effect. In addition, the discharge resistor 12 of the VLRC 1 may be a variable resistor, thermal sensitive resistor or photo-sensitive resistor. The filter element of the FCLC 3 may be a tantalum capacitor.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An LED driving circuit for a lighting feature which emits light through an LED to regulate input power to DC power sent to the LED to generate the light, comprising:
a voltage-lowering regulation circuit to regulate impedance to provide a back electromotive force opposite to input voltage;
a rectification circuit to regulate the input power to become the DC power; and
a filter and current-limiting circuit which receives the DC power and has at least one filter element to absorb or release voltage to perform filtering and at least one current-limiting resistor to limit current value of the DC power so that the DC power has a steady voltage and current to energize the LED for lighting.

2. The LED driving circuit of claim 1, wherein the voltage-lowering regulation circuit includes at least one voltage lowering capacitor and a discharge resistor that are coupled in parallel.

3. The LED driving circuit of claim 2, wherein the discharge resistor is selectively a variable resistor, a thermal sensitive resistor or a photo-sensitive resistor.

4. The LED driving circuit of claim 1, wherein the filter element of the filter and current-limiting circuit is a filter capacitor coupling in parallel with two ends of the LED, the current-limiting resistor being coupled with the LED in series.

5. The LED driving circuit of claim 4, wherein the filter element of the filter and current-limiting circuit is a tantalum capacitor.

6. The LED driving circuit of claim 1, wherein the filter element of the filter and current-limiting circuit is a diode coupled in parallel with two ends of the LED, the current-limiting resistor being coupled with the LED in series.
